(19) United States
(12) Patent Application Publication
(10) Pub. No.: US 2014/0169255 A1
(43) Pub. Date: Jun. 19, 2014

(54) OPTIMIZATION OF EMBMS SERVICE CONTINUITY WITH MBSFN MEASUREMENTS

(71) Applicant: QUALCOMM Incorporated, San Diego, CA (US)

(72) Inventors: Xiaoxia ZHANG, San Diego, CA (US); Jun WANG, Poway, CA (US); Ralph Akram GHOLMIEH, San Diego, CA (US); Nagaraju NAIK, San Diego, CA (US)

(73) Assignee: QUALCOMM Incorporated, San Diego, CA (US)

(21) Appl. No.: 14/106,685

(22) Filed: Dec. 13, 2013

Related U.S. Application Data
(60) Provisional application No. 61/738,358, filed on Dec. 17, 2012.

(51) Int. Cl. H04W 72/00

(52) U.S. Cl. CPC H04W 72/005
USPC 370/312

(57) ABSTRACT

A method, an apparatus, and a computer program product for wireless communication are provided. The apparatus configures a set of MBSFN subframes to include one or more MBSFN subframes for MBSFN signal quality measurements. The one or more MBSFN subframes for MBSFN signal quality measurements correspond to each of one or more MBSFN areas or frequencies for broadcasting eMBMS services. The apparatus sends one or more measurement parameters to a UE. The measurement parameters identify the one or more MBSFN subframes for MBSFN signal quality measurements, and a MBSFN area ID corresponding to each of the one or more MBSFN areas or frequencies. The measurement parameters may further identify a MCS level corresponding to each of the one or more MBSFN areas or frequencies.

### CROSS-REFERENCE TO RELATED APPLICATION(S)

This application claims the benefit of U.S. Provisional Application Ser. No. 61/738,358, entitled “Optimization of eMBMS Service Continuity with MBSFN Measurements” and filed on Dec. 17, 2012, which is expressly incorporated by reference herein in its entirety.

### BACKGROUND

1. Field

The present disclosure relates generally to communication systems, and more particularly, to optimization of an evolved Multimedia Broadcast Multicast Service (eMBMS) service continuity with Multicast Broadcast Single Frequency Network (MBSFN) signal quality measurements.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

A method, an apparatus, and a computer program product for wireless communication are provided. The apparatus configures a set of MBSFN subframes to include one or more MBSFN subframes for MBSFN signal quality measurements. The one or more MBSFN subframes for MBSFN signal quality measurements correspond to each of one or more MBSFN areas or frequencies for broadcasting eMBMS services. The apparatus sends one or more measurement parameters to a UE. The measurement parameters identify the one or more MBSFN subframes for MBSFN signal quality measurements, and a MBSFN area ID corresponding to each of the one or more MBSFN areas or frequencies. The measurement parameters may further identify a MCS level corresponding to each of the one or more MBSFN areas or frequencies.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7A is a diagram illustrating evolved Multimedia Broadcast Multicast Service in a Multicast Broadcast Single Frequency Network.

FIG. 7B is a diagram illustrating a format of a Multicast Channel Scheduling Information Media Access Control Element.

FIG. 8 is a flow chart of a method of wireless communication performed by an eNB.

FIG. 9 is a conceptual data flow diagram illustrating the data flow between different modules/means/components in an exemplary eNB.

FIG. 10 is a diagram illustrating an example of a hardware implementation for an eNB employing a processing system

FIG. 11 is a flow chart of a method of wireless communication performed by a UE.

FIG. 12 is a conceptual data flow diagram illustrating the data flow between different modules/means/components in an exemplary UE.

FIG. 13 is a diagram illustrating an example of a hardware implementation for an UE employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

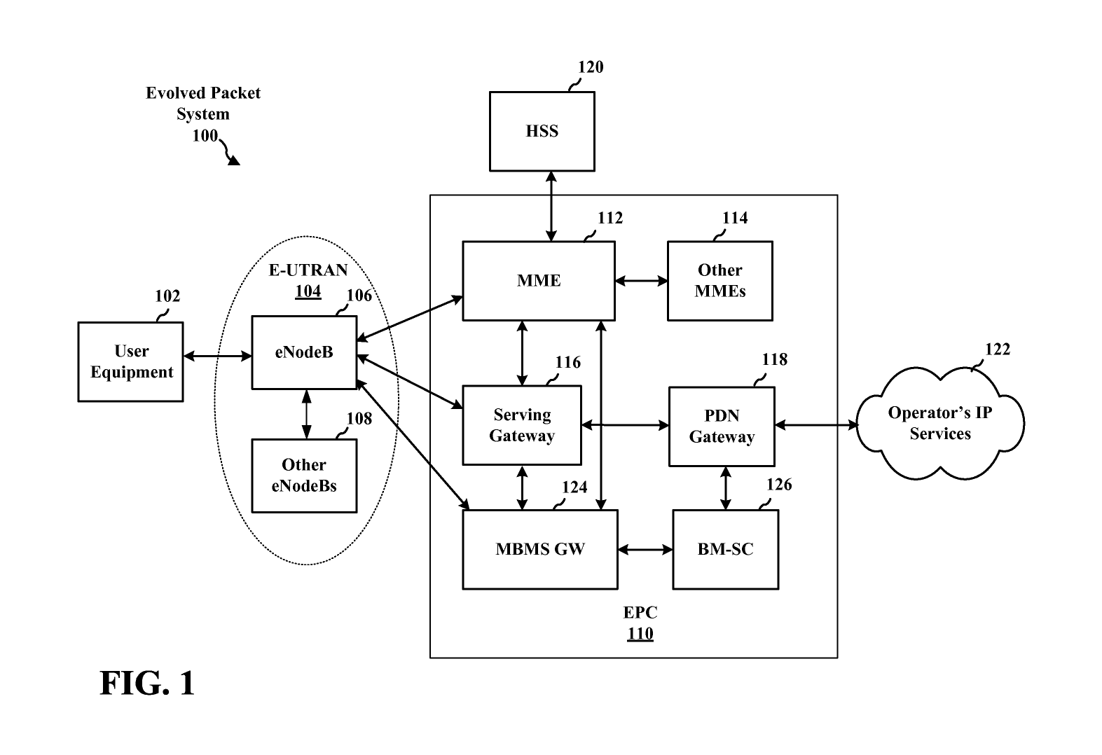

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 includes a Mobility Management Entity (MME) 112, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, an intranet, an IP Multimedia Subsystem (IMS), and a PS Streaming Service (PSS). The BM-SC 126 may provide functions for MBMS user service provisioning and delivery. The BM-SC 126 may serve as an entry point for content provider MBMS transmission, may be used to authorize and initiate MBMS Bearer Services within a PLMN and may be used to schedule and deliver MBMS transmissions. The MBMS Gateway 124 may be used to distribute MBMS traffic to eNBs belonging to an MBSFN area broadcasting a particular service, may be responsible for session management (start/stop) and for collecting eMBMS related charging information.

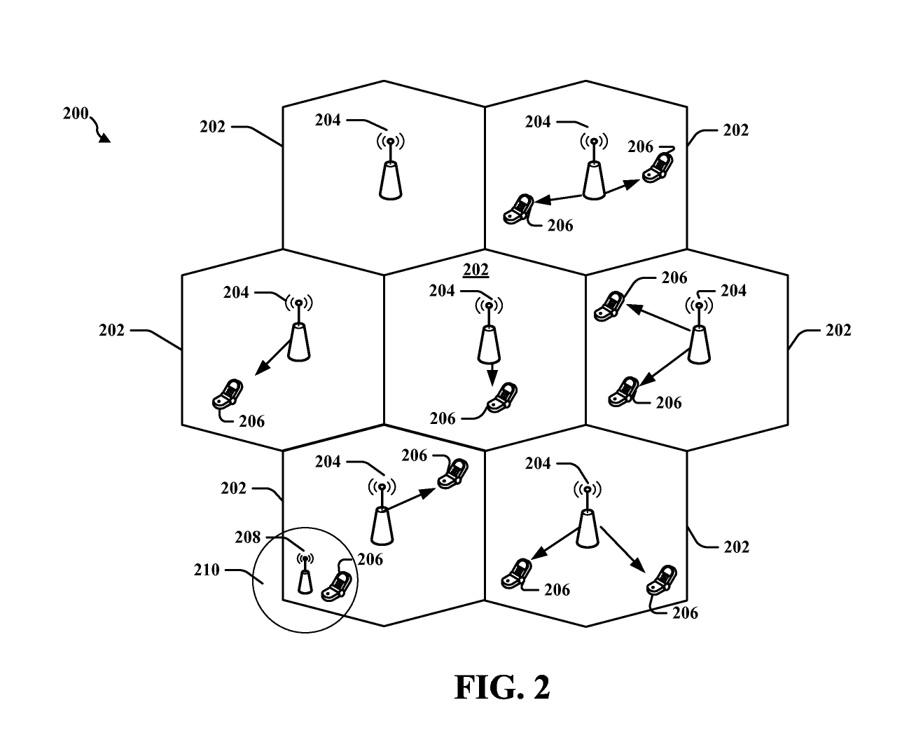

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

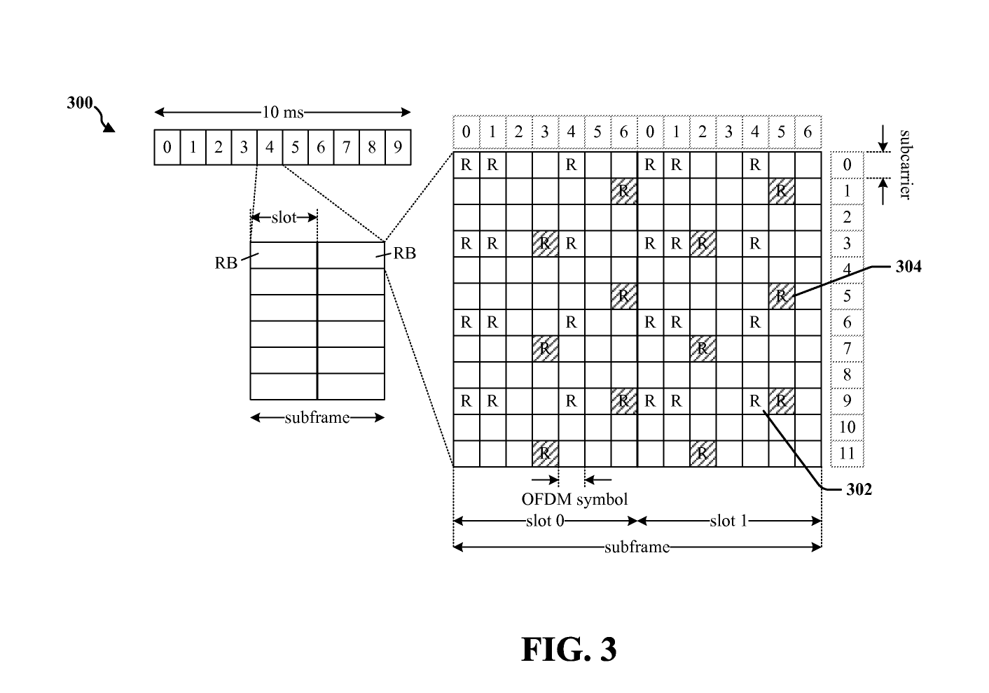

FIG. 3 is a diagram 300 illustrating an example of a DL frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block may contain 6 consecutive OFDM symbols in the time domain, or 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

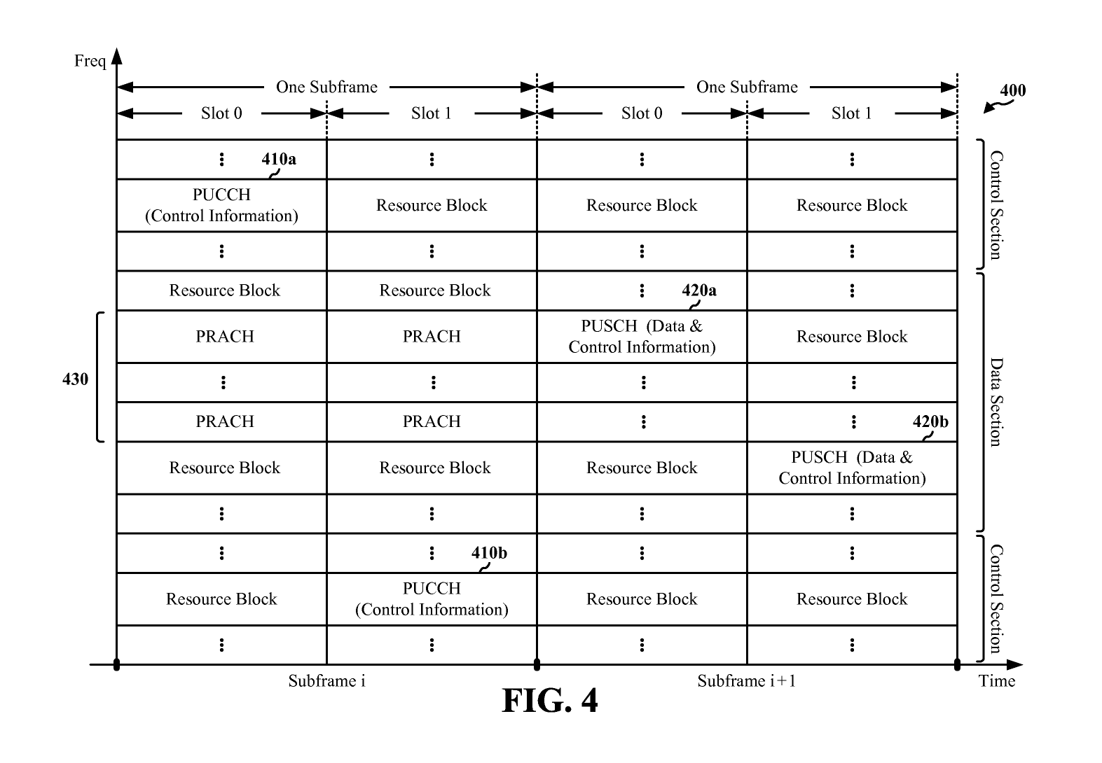

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

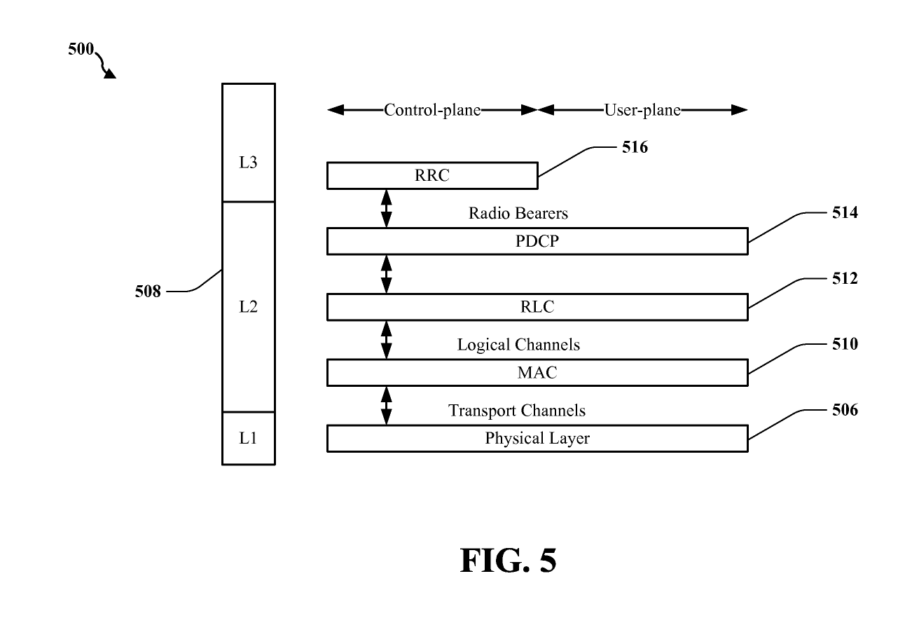

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

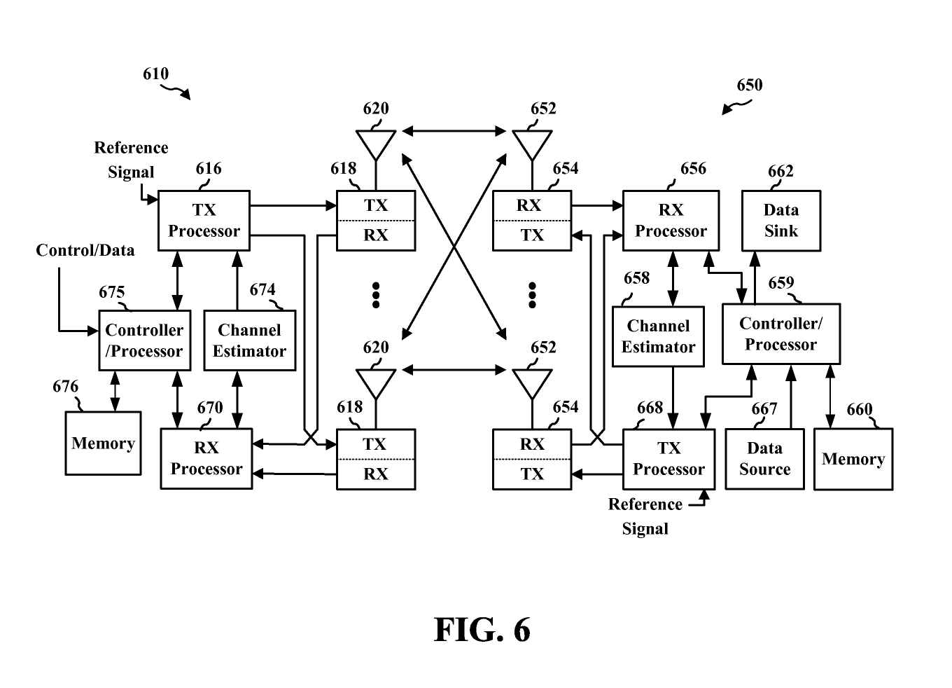

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

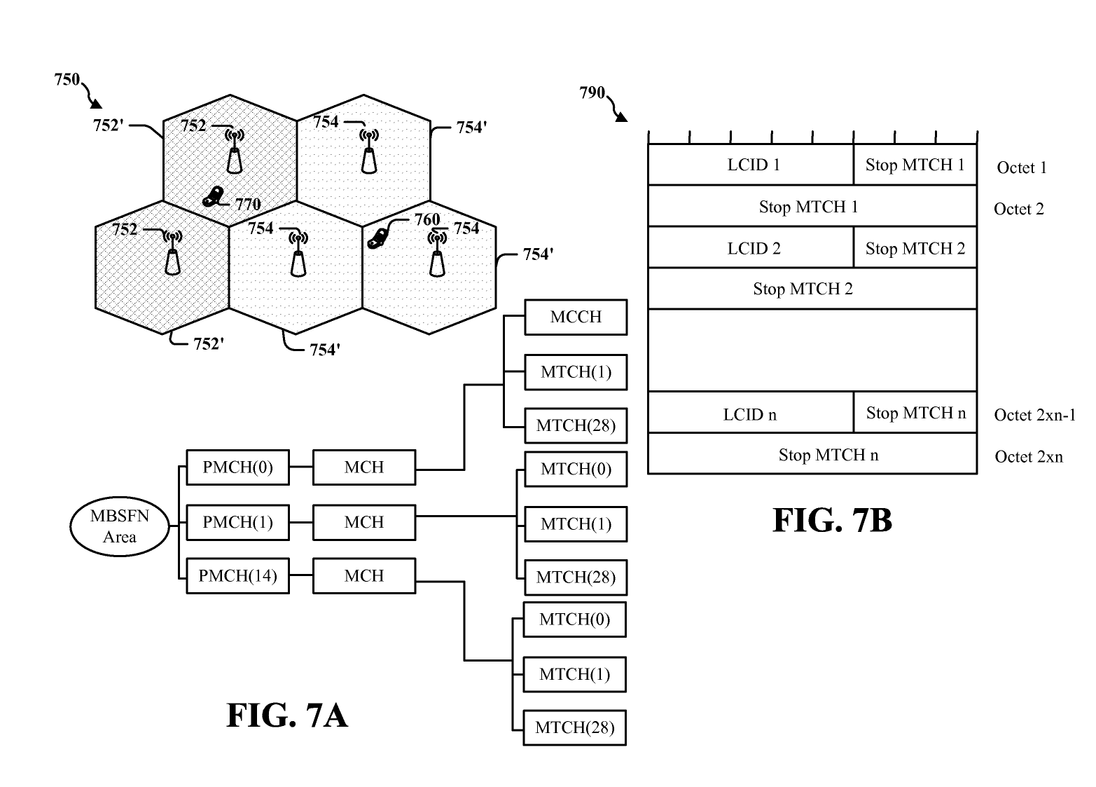

FIG. 7A is a diagram 750 illustrating evolved MBMS (eMBMS) in a Multicast Broadcast Single Frequency Network (MBSFN). The eNBs 752 in cells 752′ may form a first MBSFN area and the eNBs 754 in cells 754′ may form a second MBSFN area. The eNBs 752, 754 may each be associated with other MBSFN areas, for example, up to a total of eight MBSFN areas. A cell within an MBSFN area may be designated a reserved cell. Reserved cells do not provide multicast/broadcast content, but are time-synchronized to the cells 752′, 754′ and have restricted power on MBSFN resources in order to limit interference to the MBSFN areas. Each eNB in an MBSFN area synchronously transmits the same eMBMS control information and data. Each MBSFN area may support broadcast, multicast, and unicast services. A unicast service is a service intended for a specific user, e.g., a voice call. A multicast service is a service that may be received by a group of users, e.g., a subscription video service. A broadcast service is a service that may be received by all users, e.g., a news broadcast. Referring to FIG. 7A, the first MBSFN area may support a first eMBMS broadcast service, such as by providing a particular news broadcast to UE 770. The second MBSFN area may support a second eMBMS broadcast service, such as by providing a different news broadcast to UE 760. Each MBSFN area supports a plurality of physical multicast channels (PMCH) (e.g., 15 PMCHs). Each PMCH corresponds to a multicast channel (MCH). Each MCH can multiplex a plurality (e.g., 29) of multicast logical channels. Each MBSFN area may have one multicast control channel (MCCH). As such, one MCH may multiplex one MCCH and a plurality of multicast traffic channels (MTCHs) and the remaining MCHs may multiplex a plurality of MTCHs.

A UE can camp on an LTE cell to discover the availability of eMBMS service access and a corresponding access stratum configuration. In a first step, the UE may acquire a system information block (SIB) 13 (SIB13). In a second step, based on the SIB13, the UE may acquire an MBSFN Area Configuration message on an MCCH. In a third step, based on the MBSFN Area Configuration message, the UE may acquire an MCH scheduling information (MSI) MAC control element. The SIB13 indicates (1) an MBSFN area identifier of each MBSFN area supported by the cell; (2) information for acquiring the MCCH such as an MCCH repetition period (e.g., 32, 64, . . . , 256 frames), an MCCH offset (e.g., 0, 1, . . . , 10 frames), an MCCH modification period (e.g., 512, 1024 frames), a signaling modulation and coding scheme (MCS), subframe indices which may transmit MCCH; and (3) an MCCH change notification configuration. There may be one MBSFN Area Configuration message for each MBSFN area. The MBSFN Area Configuration message indicates (1) a temporary mobile group identity (TMGI) and an optional session identifier of each MTCH identified by a logical channel identifier within the PMCH, (2) allocated resources (i.e., radio frames and subframes) for transmitting each PMCH of the MBSFN area and the allocation period (e.g., 4, 8, . . . , 256 frames) of the allocated resources for all the PMCHs in the area, and (3) an MCH scheduling period (MSP) (e.g., 8, 16, 32, . . . , or 1024 radio frames) over which the MSI MAC Control Element is transmitted.

FIG. 7B is a diagram 790 illustrating the format of an MSI MAC Control Element. The MSI MAC Control Element is sent once each MSP. The MSI MAC Control Element is sent in the first subframe of each scheduling period of the PMCH. The MSI MAC Control Element can indicate the stop frame and subframe of each MTCH within the PMCH. There is one MSI per PMCH per MBSFN area.

In order to receive an eMBMS broadcast service a UE 760, 770 selects to a broadcast frequency of the particular MBSFN area providing the eMBMS service that is of interest to the UE, referred to herein as a “service-of-interest.” In order to maintain continuity of service, for example in cases where the quality of signals received by the UE over a current serving cell on a particular frequency becomes inadequate, the UE 760, 770 may switch or reselect to either a different cell within a different MBSFN area on the same frequency, or a different frequency within a different MBSFN area that is also broadcasting the eMBMS service-of-interest. Switching or reselecting to a different cell within the same frequency is referred to as an “intra-frequency” reselection, while reselecting to a different frequency is referred to as an “inter-frequency” reselection.

In LTE Rel-11, an additional SIB, SIB15, is introduced for the purpose of providing enhanced service continuity. The eNBs 752, 754 within a particular cell 752′, 754′ broadcast the SIB, which includes information corresponding to a broadcast service area ID (SAI) on the serving frequency, along with SAIs of one or more neighbor frequencies within the MBSFN area. Network components of the cells 752′, 754′ also broadcast a user service description (USD) list that provides the SAI (which may also be referred to as the service area index) and frequency information. Based on information included in the USD broadcast from the cell network and SIB15 broadcast by the eNBs, a UE 752′, 754′ may determine which of one or more particular frequencies are broadcasting a service-of-interest without the UE having to tune to the particular one or more frequencies and read the corresponding MCCH. This may be beneficial in that UE implementation complexity can be reduced because the UE does not have to read nor monitor the SIB15 and MCCH on different frequencies.

While the information broadcast in SIB15 and USD informs a UE of one or more frequencies broadcasting a service-of-interest, such information does not inform the UE of the signal quality on each of the frequencies. Accordingly, the UE may not be aware of whether the signal quality on a particular frequency is good enough for reception by the UE even though a service-of-interest is available on the particular frequency.

In order to determine whether the signal quality of a particular frequency is sufficient for reception by the UE, the UE may have to camp on each MBSFN frequency, receive corresponding MBSFN signals, and obtain MBSFN signal quality information, e.g., one or more of reference signal strength indicator (RSSI), reference signal received power (RSRP), a reference signal received quality (RSRQ), and signal-to noise ratio (SNR), of the signals. In order to obtain MBSFN signal quality measurements on each frequency, the UE may need to read various information including for example, SIB/MCCH/MSI/MTCH information, to allow the UE to perform the measurements. When signal quality on a particular frequency turns out to be inadequate for reception, an unnecessary frequency reselection and information reading by the UE may occur. Such unnecessary frequency switching and reading may be inefficient and result in an undesired UE experience. Furthermore, reselecting to another frequency when signal quality is insufficient for reception may increase UE implementation complexity.

Current UE cell reselection and UE handover processes may be based on measurements obtained on unicast RS signals. Generally, UE procedures in RRC idle mode are based on measurements with unicast RS signals. These measurements are obtained from unicast RS signals of the serving cell and from both intra-frequency and inter-frequency unicast RS signals from neighboring cells. Based on the measurement reports sent by the UE, the eNB may decide whether the cell is acceptable for a UE handover. Cell reselection may also be done by the UE based on the measurement reports.

During a cell reselection and handover, a UE may prioritize frequencies providing eMBMS service based on the signal measurements obtained from unicast activities on the same frequencies. However, unicast based cell reselection and handover may not account for signal quality of an eMBMS signal on a particular frequency. Furthermore, for a particular frequency, a UE may camp on the best unicast cell without considering the quality of eMBMS service provided by that cell.

In view of the foregoing, it is desirable to provide a UE information that allows the UE to obtain MBSFN signal quality and strength measurements corresponding to one or more neighbor frequencies, while the UE remains on its current serving cell, thereby reducing cell switches by the UE. Implementations described below provide for MBSFN measurements based on MBSFN signals transmitted in one or more MBSFN areas on the same frequency or on different frequencies as the current serving frequency. These one or more MBSFN areas or frequencies may include the frequency corresponding to a current serving cell and/or one or more MBSFN areas or frequencies corresponding to an intra-frequency neighbor cell or an inter-frequency neighbor cell.

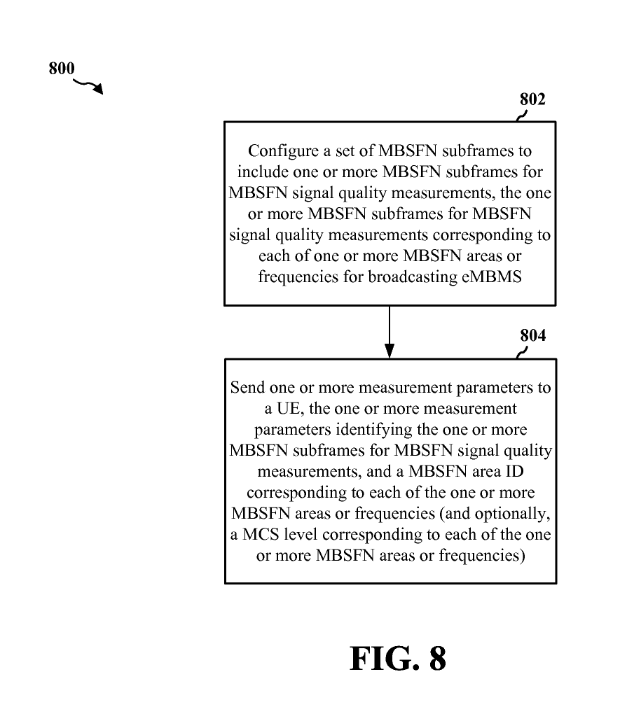

FIG. 8 is a flow chart 800 of a method of wireless communication that may be performed by an eNB associated with a serving cell. At step 802, the eNB configures a set of MBSFN subframes to include one or more MBSFN subframes for MBSFN signal quality measurements. These one or more MBSFN subframes for MBSFN signal quality measurements correspond to subframes for each of one or more MBSFN areas (formed by one or more eNBs 752 in one or more cells 7522) or MBSFN frequencies for broadcasting eMBMS services.

In one configuration, the one or more MBSFN subframes for MBSFN signal quality measurements are subframes that carry MCCH and/or MCH scheduling information (MSI). These MCCH and/or MSI subframes may be preferred over, for example MTCH subframes, because scheduling information for MCCH and/or MSI subframe transmission on a neighbor cell/frequency generally is available to the serving cell as the scheduling information is conveyed by SIB information broadcast by the neighbor cell/frequency. MTCH scheduling on a neighbor cell/frequency, however, generally is not available and can be more dynamic. Furthermore, MCCH and/or MSI subframe scheduling typically does not change often. When a scheduling change does occur, the UE may be informed of the change through a paging event sent in advance of a change in the SIB13 information. MCCH and/or MSI subframes may also be preferred because the subframes with MCCH and/or MSI information are not used for unicast transmission, whereas MBSFN subframes with MTCH information may be used for unicast by an eNB when there is not sufficient eMBMS information to utilize all of the allocated MBSFN subframes.

At step 804, the eNB sends one or more measurement parameters to a UE. The one or more measurement parameters identify the one or more MBSFN subframes for MBSFN signal quality measurements, and a MBSFN area ID corresponding to each of the one or more MBSFN areas or frequencies. As described further below, the measurement parameters may also identify a modulation and coding scheme (MCS) level corresponding to each of the one or more MBSFN areas or frequencies. The measurement parameters may be sent to a UE in a SIB, e.g., SIB15. Providing the measurement parameters in a SIB may be beneficial in that both RRC_IDLE UEs and RRC_CONNECTED UEs can acquire measurement parameters.

The one or more measurement parameters may include one or more subframe indices that identify the one or more MBSFN subframes for MBSFN signal quality measurements. For example, a measurement parameter may be a set of indices that indicates to a UE to measure MBSFN subframes 1 and 2 for a first frequency and to measure MBSFN subframes 3 and 4 for another frequency. In cases where the current serving frequency and a particular neighbor MBSFN area or frequency have different associated synchronization areas, the index may further include a system frame number (SFN) difference (or delta). In an additional aspect, the one or more measurement parameters may include a periodicity along with subframe numbers the UE should measure. In this case, the periodicity defines how often the measurements are made within a period of subframes. For example, the periodicity may specify that the UE measure every other subframe corresponding to the identified subframe numbers. Instances of identified subframe numbers that are not measured by the UE are available for eMBMS reception. Accordingly, the UE avoids conducting measurements during eMBMS reception on the current frequency. The periodic measurement of MBSFN subframes as described functions like a measurement gap for unicast measurements, which allow a UE to monitor another frequency without interfering with reception on the current frequency.

MBSFN area IDs may be provided for each frequency so that the UE may decode MBSFN signals that were scrambled. The MBSFN area ID determines the descrambling code used by the UE.

The measurement parameters described above may be insufficient for a UE to determine whether the MBSFN signal quality on a neighbor cell/frequency is sufficient for eMBMS reception. Generally the MCS of an eMBMS transmission requires a minimum signal quality so that it can be decoded at an acceptable quality of service, e.g., signal-to-noise ratio (SNR) level required for reception at a 1% block error rate (BLER). For example, an MCS level of 15 may require a minimum SNR of 15 dB for acceptable reception. Typically, a UE measures the SNR of a cell/frequency and, based on available MSC-to-SNR mapping information, determines whether the traffic channel of interest can be received at an acceptable quality of service based on the MCS in use for that traffic channel. If the SNR is higher than the SNR required for good reception for the MCS in use then the UE will have good eMBMS reception. Alternatively, the UE can measure the SNR, determine the highest MCS (the higher the MCS number, the less robust it is) that can be supported. As long as the MCS is lower than this highest MCS for the SNR level, the UE should have good eMBMS reception.

In the case of a neighbor cell/frequency the UE is generally not aware of scheduled MCS level requirements on a neighbor cell/frequency for acceptable reception of eMBMS service. As such, the UE is not able to determine if the MBSFN signal quality on a neighbor cell/frequency is sufficient for eMBMS reception based only on SNR measurements on neighbor. In one approach of addressing this issue, the UE may switch to a neighbor cell/frequency, read the corresponding SIBs and MCCH, determine the subframes and scheduled MCS levels for a MTCH of interest to the UE and measure corresponding MBSFN signals. Then the UE may determine that the neighbor cell/frequency has a signal quality sufficient to meet the scheduled MCS level necessary for good reception. This approach, however, is undesirable because it requires the UE to switch to each neighbor cell/frequency to determine if the signal quality on each cell/frequency is acceptable.

To address the foregoing issue, in various embodiments, the one or more measurement parameters sent by the eNB may further identify a MCS level for each of the one or more MBSFN areas and frequencies. The one or more measurement parameters may be explicitly provided in a SIB, e.g., SIB15, or may be implicitly provided via a mapping operation described further below.

Each MBSFN area may have multiple PMCHs. The PMCHs may have different MCS levels, thereby resulting in different MCS levels within the same MBSFN area. Accordingly, the eNB may provide one MCS level (e.g., a maximum MCS) for each neighbor frequency in the SIB. Alternatively, the eNB may provide a MCS level range bound by a minimum MCS and a maximum MCS among all PMCHs that carry eMBMS services.

As mentioned above, scheduled MCS levels may be provided via a mapping operation. This mapping operation maps service area IDs (SAI) to MCS levels, wherein each of the one or more MBSFN areas or frequencies has an associated SAI. This mapping operation may be provided to a UE independent of a SIB, for example by a user service description (USD) or by an access network discovery and selection function (ANDSF) signal.

In cases where each frequency may support multiple MBSFN areas, measurement parameters are provided for each MBSFN area, per frequency. The UE can use the measured MBSFN signals to determine which MBSFN area offers the best signal quality on each frequency. A measurement bandwidth for obtaining measurements may also be included as a measurement parameter and signaled in a SIB. If a measurement bandwidth is not provided, the UE may use a minimum bandwidth for measurements, e.g., a bandwidth corresponding to center 6 resource blocks.

A UE may only need to perform MBSFN measurements when a SIB indicates a particular frequency belongs to a SAI with a service-of-interest. Accordingly, the measurement parameters may further include an indication of SAI to physical cell ID (PCI) for each of the one or more MBSFN areas or frequencies. If a SAI to PCI list is given for each frequency in a SIB, e.g., SIB 15, the UE can further minimize measurement by only considering those cells identified by PCIs in the corresponding SAI. For example, if a SAI covers PCI x, y, and z, and a neighbor cell does not belong to x, y, z, then the UE does not perform measurements for that cell, because the UE knows the cell does not carry the service-of-interest. This may narrow down the number of cells on which a UE performs MBSFN measurements.

The measurement parameters may also include an indication of SAI to MBSFN area ID for each of the one or more MBSFN areas or frequencies. If a SAI to MBSFN area ID list is provided for each frequency in addition to a SAI to PCI list, a UE can further minimize MBSFN measurements by only considering corresponding PCIs and MBSFN areas. For example, based on these indications, a UE may determine that eMBMS service X is carried in MBSFN area ID 0 and MBSFN area ID 1 but is not carried in MBSFN area ID 2. As a result, the UE does not perform MBSFN measurements on MBSFN area ID 2. This may further narrow down the number of cells on which a UE performs MBSFN measurements.

A measurement gap for MBSFN measurements may be introduced, in various embodiments, for a UE to perform inter-frequency MBSFN measurements. To this end, the eNB schedules unicast activity so as to avoid unicast transmission in subframes corresponding to the measurement gap. The subframes corresponding to the measurement gap are MBSFN subframes during which a UE may perform MBSFN measurements on another MBSFN area and frequency. The eNB informs the UE of the measurement gap subframes on the neighbor frequency where the UE can perform MBSFN measurements, while avoiding the scheduling of any unicast data in those subframes. In addition, the eNB/MCE may schedule various information, including MCCH/MSI information, for the current MBSFN area and frequency so that that the reading of the MCCH/MSI information by the UE does not collide with the reading by the UE of MCCH/MSI information on a neighbor MBSFN area and frequency. In this way, the UE can read MCCH/MSI information for the UE's current MBSFN area and frequency without affecting MBSFN measurements on neighbor MBSFN area and frequency.

In certain embodiments, the UE has a scheduled MCS level to MBSFN signal quality mapping table so that the UE is aware of whether a measured MBSFN signal quality satisfies a scheduled MCS level requirement. The UE may update such mapping table based on reception experience.

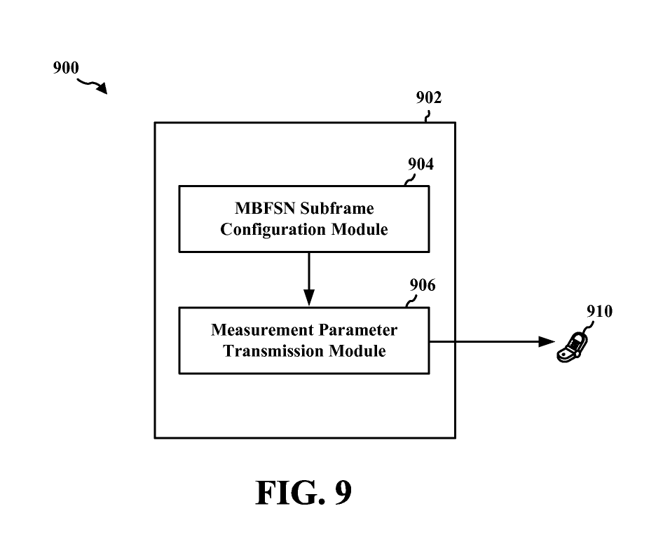

FIG. 9 is a conceptual data flow diagram 900 illustrating the data flow between different modules/means/components in an exemplary apparatus 902. The apparatus may be an eNB. The apparatus 902 includes a MBSFN subframe configuration module 904 that configures a set of MBSFN subframes to include one or more MBSFN subframes for MBSFN signal quality measurements. The one or more MBSFN subframes for MBSFN signal quality measurements correspond to each of one or more MBSFN areas or frequencies for broadcasting eMBMS services. The apparatus 902 also includes a measurement parameter transmission module 906 that sends one or more measurement parameters to a UE 910. The one or more measurement parameters identify the one or more MBSFN subframes for MBSFN signal quality measurements, and a MBSFN area ID corresponding to each of the one or more MBSFN areas or frequencies. The measurement parameters may also indentify a MCS level corresponding to each of the one or more MBSFN areas or frequencies.

The apparatus 902 may include additional modules that perform each of the steps of the algorithm in the aforementioned flow chart of FIG. 8. As such, each step in the aforementioned flow chart of FIG. 8 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

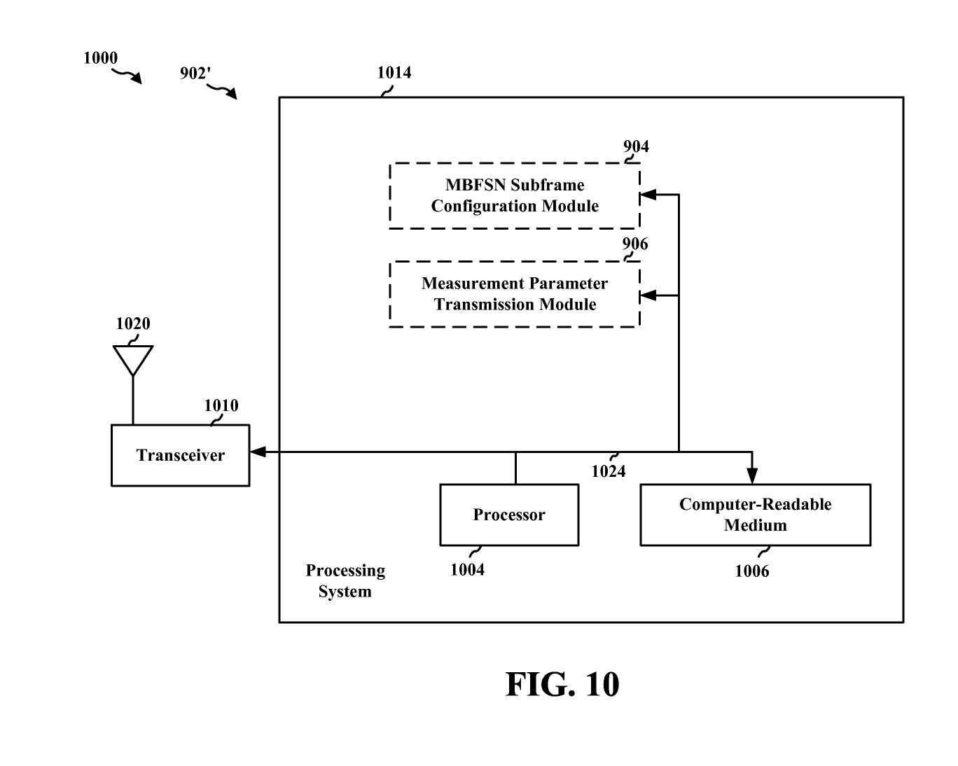

FIG. 10 is a diagram 1000 illustrating an example of a hardware implementation for an apparatus 902′ employing a processing system 1014. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware modules, represented by the processor 1004, the modules 904, 906, and the computer-readable medium 1006. The bus 1024 may also link various other circuits such as timing sources, peripherals, voltage regulators, and power management circuits, which are well known in the art, and therefore, will not be described any further.

The processing system 1014 may be coupled to a transceiver 1010. The transceiver 1010 is coupled to one or more antennas 1020. The transceiver 1010 provides a means for communicating with various other apparatus over a transmission medium. The transceiver 1010 receives a signal from the one or more antennas 1020, extracts information from the received signal, and provides the extracted information to the processing system 1014. In addition, the transceiver 1010 receives information from the processing system 1014, specifically the measurement parameter transmission module 906, and based on the received information, generates a signal to be applied to the one or more antennas 1020. The processing system 1014 includes a processor 1004 coupled to a computer-readable medium 1006. The processor 1004 is responsible for general processing, including the execution of software stored on the computer-readable medium 1006. The software, when executed by the processor 1004, causes the processing system 1014 to perform the various functions described supra for any particular apparatus. The computer-readable medium 1006 may also be used for storing data that is manipulated by the processor 1004 when executing software. The processing system further includes at least one of the modules 904 and 906. The modules may be software modules running in the processor 1004, resident/stored in the computer readable medium 1006, one or more hardware modules coupled to the processor 1004, or some combination thereof. The processing system 1014 may be a component of the eNB 610 and may include the memory 676 and/or at least one of the TX processor 616, the RX processor 670, and the controller/processor 675.

In one configuration, the apparatus 902/902′ for wireless communication includes means for configuring a set of MBSFN subframes to include one or more MBSFN subframes for MBSFN signal quality measurements. The one or more MBSFN subframes for MBSFN signal quality measurements correspond to each of one or more MBSFN areas or frequencies for broadcasting eMBMS services. The apparatus 902/902′ also includes means for sending one or more measurement parameters to a UE. The one or more measurement parameters identify the one or more MBSFN subframes for MBSFN signal quality measurements, and a MBSFN area ID corresponding to each of the one or more MBSFN areas or frequencies.

The aforementioned means may be one or more of the aforementioned modules of the apparatus 902 and/or the processing system 1014 of the apparatus 902′ configured to perform the functions recited by the aforementioned means. As described supra, the processing system 1014 may include the TX Processor 616, the RX Processor 670, and the controller/processor 675. As such, in one configuration, the aforementioned means may be the TX Processor 616, the RX Processor 670, and the controller/processor 675 configured to perform the functions recited by the aforementioned means.

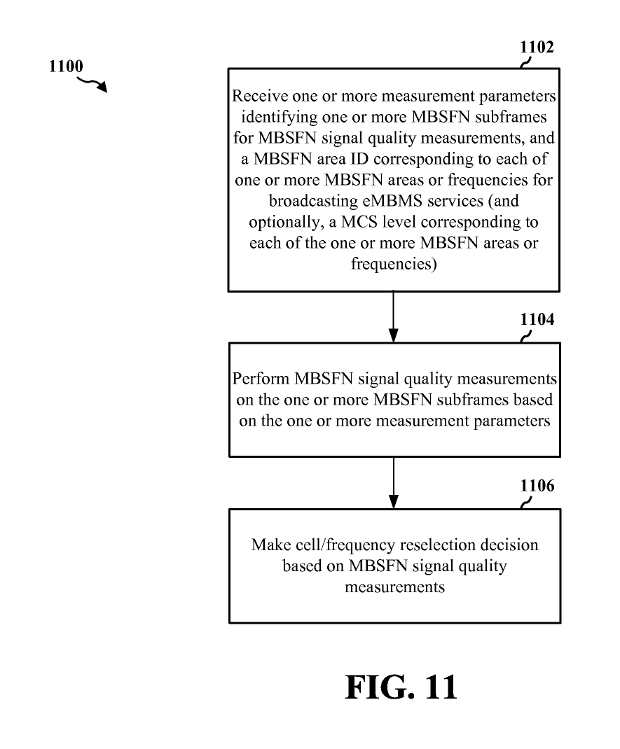

FIG. 11 is a flow chart 1100 of a method of wireless communication performed by a UE. At step 1102, the UE receives one or more measurement parameters. The measurement parameters identify one or more MBSFN subframes for MBSFN signal quality measurements, and a MBSFN area ID corresponding to each of one or more MBSFN areas or frequencies for broadcasting eMBMS services. The MBSFN subframes for MBSFN signal quality measurements may vary among different MBSFN areas and frequencies. Optionally, the measurement parameters may further identify a MCS level corresponding to each of the one or more MBSFN areas or frequencies.

At step 1104, the UE performs MBSFN signal quality measurements on the one or more MBSFN subframes based on the one or more measurement parameters. These MBSFN signal quality measurements may include RSSI, RSRP, RSRQ and SNR and may be performed using known techniques.

At step 1106, the UE makes cell/frequency selection or reselection decisions based on the MBSFN signal quality measurements. For example, in cases where MCS levels are identified in the measurement parameters, a MCS level criteria corresponding to each of the one or more MBSFN areas or frequencies may be provided. The UE may consider a frequency having MBSFN signal quality measurements that satisfy the MCS level criteria to be an acceptable frequency for reselection. The MCS level may be a maximum MCS level, in which case the UE considers the criteria satisfied when the MBSFN signal quality measurements are at or above the maximum MCS level. The MCS level may, alternatively, be a MCS level range having a maximum MCS level and a minimum MSC level, in which case the UE considers the criteria satisfied when the MBSFN signal quality measurements are at or above the maximum MCS level; possibly satisfied when the MBSFN signal quality measurements are between the minimum MCS level and the maximum MCS level; and not satisfied when the MBSFN signal quality measurements are below the minimum MCS level.

Continuing with step 1106, the UE may make a cell/frequency reselection decision based on a number of MBSFN signal quality measurements from different cells/frequencies, including possibly both intra-frequency cells and inter-frequency cells. This is distinct over conventional reselection based on unicast measurements, wherein a UE reselects to a frequency having the best unicast measurements without considering eMBMS service quality. In one implementation, a UE may identify a number of eMBMS candidate cells for reselection based on MBSFN signal quality measurements. For example, a cell in a SAI that offers a service-of-interest to the UE may be considered an eMBMS candidate cell if the MBSFN measurements for that cell meet the scheduled MCS level(s) indicated for the cell. In other words, the the measured signal quality is sufficient for eMBMS reception.

The UE may then rank the identified eMBMS candidate cells based on their respective MBSFN signal quality measurements. For example, the UE may rank eMBMS candidate cells based on MBSFN signal quality. In the case of similarly ranked identified eMBMS candidate cells, the UE ranks these cells based on unicast measurements. For example, eMBMS candidate cells corresponding to the same MBSFN area generally have the same MBSFN signal strength/quality and thus may have the same ranking Out of these similarly ranked cells, the UE ranks eMBMS candidate cells that fulfill cell selection criterion based on unicast measurements as specified in Section 5.2.4.6 of 3GPP TS 36.304, version 11.5.0. The UE then selects the identified eMBMS candidate cell having the highest rank for cell reselection. In cases where no candidate cells in the SAI fulfill the cell selection criterion, the UE may consider a cell not in the SAI to PCI list for reselection.

A UE may use the signal quality information obtained to assist in prioritization of eMBMS frequencies. In the case of duplicated content broadcast over different frequencies, the UE may use the signal quality information to select a frequency to use for best reception of broadcast content on a given service ID (TMGI), e.g., CNN, Fox News. The UE may also use the signal quality information to access lower priority content on another frequency while waiting for a measurement, e.g. SNR, to become satisfactory on the frequency carrying the higher priority content.

For RRC_IDLE UEs, the MBSFN signal quality information may allow a UE to prioritize a certain frequency during cell reselection. For RRC_CONNECTED UEs, the signal quality information may allow a UE to signal a certain frequency in MBMSInterestIndication. In addition to current UE procedures in idle mode as defined in 3GPP TS 36.304, a UE may consider a MBMS frequency to be the highest priority during the MBMS session if the MBSFN measurements are sufficient for service reception. A UE may signal a frequency in MBMSInterestIndication when measurements on that frequency are good for reception and that frequency belongs to an SAI with a service-of-interest. In the event there are two candidate MBMS frequencies, a UE can further prioritize one frequency based on service priority if the MBSFN signal quality measurements on both frequencies are sufficient for reception. Service priority in this context is based on the level of interest a UE may have in a particular service over another particular service. Even with a UE having carrier aggregation (CA) capability, the UE can choose not to listen to services sent on one carrier if corresponding MBSFN signal quality measurements indicate an MBSFN signal is not good for reception.

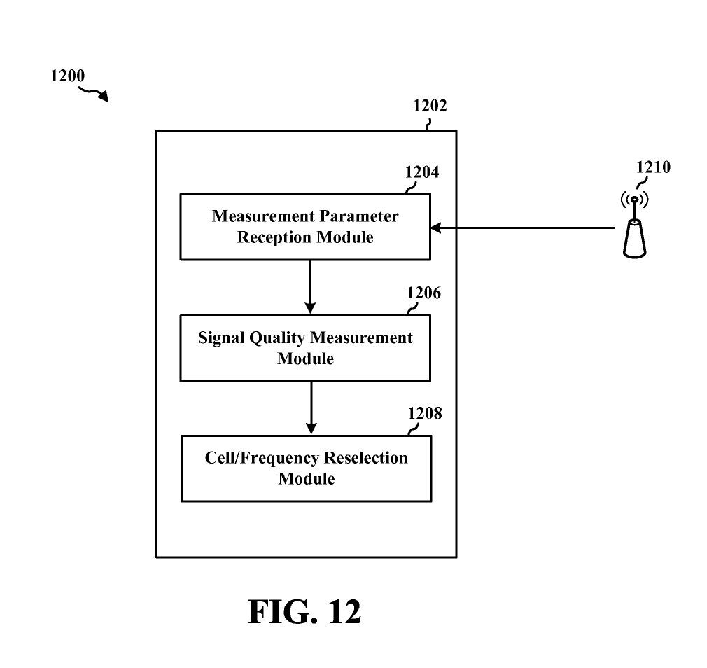

FIG. 12 is a conceptual data flow diagram 1200 illustrating the data flow between different modules/means/components in an exemplary apparatus 1202. The apparatus may be a UE. The apparatus includes a measurement parameter reception module 1204 that receives one or more measurement parameters. The measurement parameters identify one or more MBSFN subframes for MBSFN signal quality measurements, and a MBSFN area ID corresponding to each of one or more MBSFN areas or frequencies for broadcasting eMBMS services. Optionally, the measurement parameters may further identify a MCS level corresponding to each of the one or more MBSFN areas or frequencies. The apparatus also includes a signal quality measurement module 1206 that performs MBSFN signal quality measurements on the one or more MBSFN subframes based on the one or more measurement parameters, and a cell/frequency reselection module 1208 that makes a cell/frequency reselection decision based on a number of MBSFN signal quality measurements from different cells/frequencies.

The apparatus may include additional modules that perform each of the steps of the algorithm in the aforementioned flow chart of FIG. 11. As such, each step in the aforementioned flow chart of FIG. 11 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof

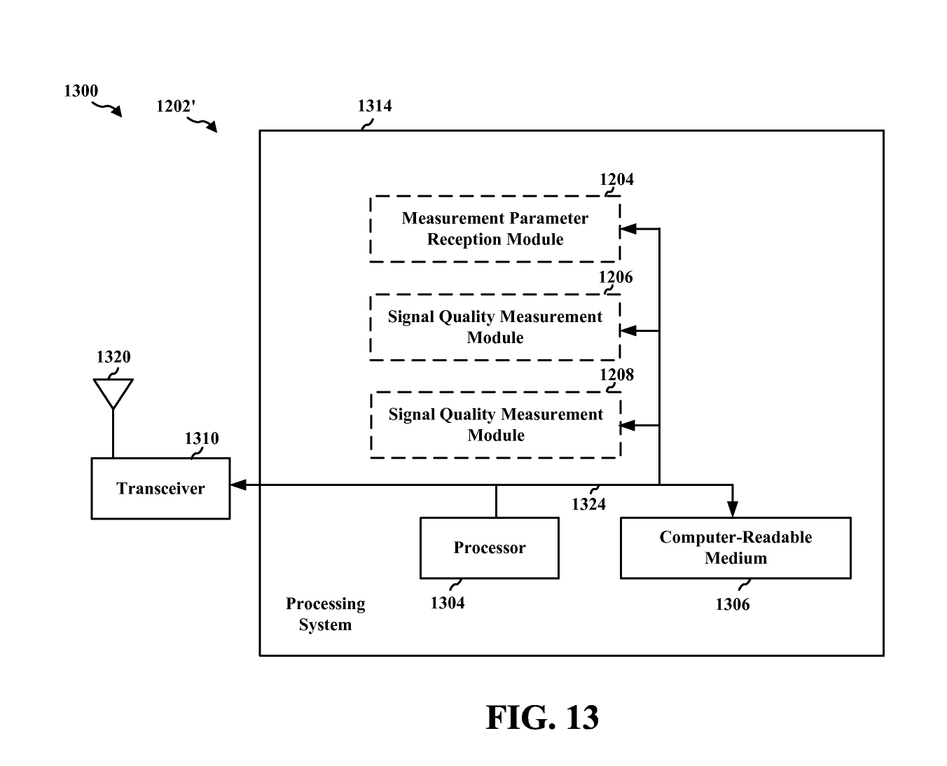

FIG. 13 is a diagram 1300 illustrating an example of a hardware implementation for an apparatus 1202′ employing a processing system 1314. The processing system 1314 may be implemented with a bus architecture, represented generally by the bus 1324. The bus 1324 may include any number of interconnecting buses and bridges depending on the specific application of the processing system 1314 and the overall design constraints. The bus 1324 links together various circuits including one or more processors and/or hardware modules, represented by the processor 1304, the modules 1204, 1206, 1208, and the computer-readable medium 1306. The bus 1324 may also link various other circuits such as timing sources, peripherals, voltage regulators, and power management circuits, which are well known in the art, and therefore, will not be described any further.

The processing system 1314 may be coupled to a transceiver 1310. The transceiver 1310 is coupled to one or more antennas 1320. The transceiver 1310 provides a means for communicating with various other apparatus over a transmission medium. The transceiver 1310 receives a signal from the one or more antennas 1320, extracts information from the received signal, and provides the extracted information to the processing system 1314, specifically the measurement parameter receiving module 1204. In addition, the transceiver 1310 receives information from the processing system 1314, and based on the received information, generates a signal to be applied to the one or more antennas 1320. The processing system 1314 includes a processor 1304 coupled to a computer-readable medium 1306. The processor 1304 is responsible for general processing, including the execution of software stored on the computer-readable medium 1306. The software, when executed by the processor 1304, causes the processing system 1314 to perform the various functions described supra for any particular apparatus. The computer-readable medium 1306 may also be used for storing data that is manipulated by the processor 1304 when executing software. The processing system further includes at least one of the modules 1204, 1206, and 1208. The modules may be software modules running in the processor 1304, resident/stored in the computer readable medium 1306, one or more hardware modules coupled to the processor 1304, or some combination thereof. The processing system 1314 may be a component of the UE 650 and may include the memory 660 and/or at least one of the TX processor 668, the RX processor 656, and the controller/processor 659.

In one configuration, the apparatus 1202/1202′ for wireless communication includes means for receiving one or more measurement parameters identifying one or more MBSFN subframes for MBSFN signal quality measurements, and a MBSFN area ID corresponding to each of one or more MBSFN areas or frequencies for broadcasting eMBMS services. The apparatus 1202/1202′ also includes means for performing MBSFN signal quality measurements on the one or more MBSFN subframes based on the one or more measurement parameters, and means for making a cell/frequency reselection decision based on a number of MBSFN signal quality measurements from different cells/frequencies.

The aforementioned means may be one or more of the aforementioned modules of the apparatus 1202 and/or the processing system 1314 of the apparatus 1202′ configured to perform the functions recited by the aforementioned means. As described supra, the processing system 1314 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

In another implementation, an eNB configured similar to the eNB of FIGS. 6, 9 and 10, configures a set of MBSFN subframes to include one or more MBSFN subframes for MBSFN signal quality measurements. The one or more MBSFN subframes for MBSFN signal quality measurements correspond to subframes that carry MCCH information, and further correspond to each of one or more MBSFN areas or frequencies for broadcasting eMBMS services. The eNB sends one or more measurement parameters to UE, for example over a SIB. The one or more measurement parameters identify the one or more MBSFN subframes for MCCH detection, a MCS level corresponding to the MCCH, a MBSFN area ID corresponding to each of the one or more MBSFN areas or frequencies, a MCCH transmission bandwidth, and a number of control symbols in the one or more MBSFN subframes. The latter parameters may be used by a UE to decode MCCH on a neighbor cell/frequency. Based on the SNR of the received MCCH, a UE may determine whether a measured signal quality is good for reception.

In this embodiment, a UE configured similar to the UE of FIGS. 6, 12 and 13, receives one or more measurement parameters identifying one or more MBSFN subframes for MBSFN signal quality measurements corresponding to subframes that carry MCCH information, a MCS level corresponding to the MCCH, a MBSFN area ID corresponding to each of one or more MBSFN areas or frequencies for broadcasting eMBMS services, a MCCH transmission bandwidth, and a number of control symbols in the one or more MBSFN subframes. The UE performs MBSFN signal quality measurements on the one or more MBSFN subframes based on the one or more measurement parameters. In this implementation, switching overhead may be reduced as the UE does not need to acquire SIBs on neighbor cell(s)/frequency(ies) to read the corresponding MCCH. However, the UE decodes the MCCH, which may result in higher UE complexity as compared to UE complexity for performing measurements based on MBSFN reference signals.

While the foregoing implementations have described configuring a set of MBSFN subframes for signal quality measurements, in more basic implementations, general ancillary information is provided to a UE that helps the UE determine whether the MBSFN signal quality on a different MBSFN are or neighbor frequency is satisfactory for eMBMS content consumption. To this end, an eNB may send one or more measurement parameters to a UE. The one or more measurement parameters allow the UE to conduct MBSFN signal quality measurements on one or more MBSFN signals carried on one or more MBSFN areas or neighbor frequencies broadcasting eMBMS content. The eNB may configure a set of MBSFN subframes to include one or more MBSFN subframes for MBSFN signal quality measurements. The one or more MBSFN subframes for MBSFN signal quality measurements may correspond to each of the one or more MBSFN areas or frequencies for broadcasting eMBMS services. The one or more measurement parameters may identify the one or more MBSFN subframes for signal quality measurements, and a MBSFN area ID corresponding to each of the one or more frequencies. The eNB may also provide measurement parameters that do not include configuring subframes for measurements. For example, the one or more measurement parameters provided by the eNB may identify a MCS level corresponding to each of the one or more MBSFN areas or frequencies. For a frequency that supports a plurality of MBSFN areas, the measurement parameters for that frequency may identify separate parameters for each MBSFN area supported by that frequency. The separate parameters identified for each MBSFN area for a frequency may include one or more parameters that are the same for some of the MBSFN areas supported by the frequency and one or more parameters that are different.

In this implementation, a UE receives one or more measurement parameters. The one or more measurement parameters allow the UE to conduct MBSFN signal quality measurements on one or more MBSFN signals carried on one or more MBSFN areas or neighbor frequencies broadcasting eMBMS content. The UE performs MBSFN signal quality measurements based on the one or more measurement parameters.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication of a base station, comprising:
configuring a set of Multicast Broadcast Single Frequency Network (MBSFN) subframes to include one or more MBSFN subframes for MBSFN signal quality measurements, the one or more MBSFN subframes for MBSFN signal quality measurements corresponding to each of one or more MBSFN areas or frequencies for broadcasting evolved Multimedia Broadcast Multicast Service (eMBMS) services; and
sending one or more measurement parameters to a user equipment (UE), the one or more measurement parameters identifying the one or more MBSFN subframes for MBSFN signal quality measurements, and a MBSFN area ID corresponding to each of the one or more MBSFN areas or frequencies.

2. The method of claim 1, wherein the one or more MBSFN subframes for MBSFN signal quality measurements comprise subframes that carry multicast control channel (MCCH) and/or MCCH/multicast channel (MCH) scheduling information (MSI).

3. The method of claim 1, wherein sending one or more measurement parameters to a UE comprises broadcasting one or more of the one or more measurement parameters in a system information block (SIB).

4. The method of claim 1, wherein the one or more measurement parameters comprises one or more subframe numbers that identify the one or more MBSFN subframes for MBSFN signal quality measurements.

5. The method of claim 1, wherein the one or more measurement parameters comprises an index that identifies the one or more MBSFN subframes for MBSFN signal quality measurements.

6. The method of claim 5, wherein a current serving frequency and a particular neighbor MBSFN area or frequency have different associated synchronization areas and the index further includes a system frame number difference.

7. The method of claim 1, wherein the one or more measurement parameters comprises a Modulation and Coding Scheme (MCS) level corresponding to each of the one or more MBSFN areas or frequencies.

8. The method of claim 1, wherein, for a frequency that supports a plurality of MBSFN areas, the measurement parameters for that frequency identify separate parameters for each MBSFN area supported by that frequency.

9. The method of claim 1, wherein the measurement parameters comprise a measurement bandwidth.

10. The method of claim 1, wherein the measurement parameters further comprise an indication of SAI to Physical Cell ID (PCI) for each of the one or more MBSFN areas or frequencies.

11. The method of claim 1, wherein the measurement parameters further comprise an indication of SAI to MBSFN area ID for each of the one or more MBSFN areas or frequencies.

12. The method of claim 1, further comprising informing the UE of a measurement gap for performing inter-frequency MBSFN measurements, the informing occurring through dedicated signaling to the UE.

13. An apparatus for wireless communication, comprising:
means for configuring a set of Multicast Broadcast Single Frequency Network (MBSFN) subframes to include one or more MBSFN subframes for MBSFN signal quality measurements, the one or more MBSFN subframes for MBSFN signal quality measurements corresponding to each of one or more MBSFN areas or frequencies for broadcasting evolved Multimedia Broadcast Multicast Service (eMBMS) services; and
means for sending one or more measurement parameters to a user equipment (UE), the one or more measurement parameters identifying the one or more MBSFN subframes for MBSFN signal quality measurements, and a MBSFN area ID corresponding to each of the one or more MBSFN areas or frequencies.

14. The apparatus of claim 13, wherein the one or more MBSFN subframes for MBSFN signal quality measurements comprise subframes that carry multicast control channel (MCCH) and/or MCCH/multicast channel (MCH) scheduling information (MSI).

15. A method of wireless communication of a user equipment, comprising:
receiving one or more measurement parameters identifying one or more MBSFN subframes for MBSFN signal quality measurements, and a MBSFN area ID corresponding to each of one or more MBSFN areas or frequencies for broadcasting evolved Multimedia Broadcast Multicast Service (eMBMS) services; and
performing MBSFN signal quality measurements on the one or more MBSFN subframes based on the one or more measurement parameters.

16. The method of claim 15, wherein the measurement parameters further identify a Modulation and Coding Scheme (MCS) level corresponding to each of the one or more MBSFN areas or frequencies.

17. The method of claim 16, wherein the MCS level comprises a MCS level criteria corresponding to each of the one or more MBSFN areas or frequencies, and a frequency having MBSFN signal quality measurements that satisfy the MCS level criteria is considered an acceptable frequency for reselection.

18. The method of claim 17, wherein the MCS level criteria comprises a maximum MCS level and the criteria is considered satisfied when the MBSFN signal quality measurements are at or above the maximum MCS level.

19. The method of claim 17, wherein the MCS level criteria comprises a MCS level range having a maximum MCS level and a minimum MSC level and the criteria is considered:
satisfied when the MBSFN signal quality measurements are at or above the maximum MCS level;
possibly satisfied when the MBSFN signal quality measurements are between the minimum MCS level and the maximum MCS level; and
not satisfied when the MBSFN signal quality measurements are below the minimum MCS level.

20. The method of claim 15, further comprising:
identifying a plurality of eMBMS candidate cells based on MBSFN signal quality measurements;
ranking identified eMBMS candidate cells based on MBSFN signal quality measurements;
for similarly ranked identified eMBMS candidate cells, ranking the cells based on unicast measurements; and
selecting the identified eMBMS candidate cell having the highest rank for cell reselection.
